(19) United States
(12) Patent Application Publication
(10) Pub. No.: US 2010/0213274 A1
(43) Pub. Date: Aug. 26, 2010

(54) Microdroplet Generation Apparatus

(75) Inventors: Shan-Yi Yu, Taipei County (TW); Han-Chang Liu, Taipei County (TW); Wen-Yu Tsai, Taipei County (TW)

Correspondence Address: SCHMEISER OLSEN & WATTS, 18 E UNIVERSITY DRIVE, SUITE # 101, MESA, AZ, 85201, US

(73) Assignee: Health & Life Co., Ltd., Taipei County (TW)

(21) Appl. No.: 12/482,647

(22) Filed: Jun. 11, 2009

(30) Foreign Application Priority Data
Feb. 25, 2009 (TW) 098202839

(51) Int. Cl. B05B 1/08

(52) U.S. Cl. 239/102.2

(57) ABSTRACT

A microdroplet generation apparatus comprises an oscillation plate, a connection plate, a nozzle disc and a bonding material, wherein the nozzle disc is interposed between the oscillation plate and connection plate, and wherein the oscillation plate, connection plate and nozzle disc are joined with the bonding material. The oscillation plate and the connection plate respectively have a first through-hole and a second through-hole corresponding to each other. The nozzle disc has injection holes on the area corresponding to the first and second through-holes. The nozzle disc has via-holes on the area not corresponding to the first through-hole and the second through-hole. The bonding material passes through the via-holes of the nozzle disc to join the oscillation plate and the connection plate and fasten the nozzle disc to between the oscillation plate and the connection plate. Thus, vibration energy can be effectively transmitted from the vibration plate to the nozzle disc.

### BACKGROUND OF THE INVENTION

1. Field of the Invention

The present invention relates to a microdroplet generation apparatus applying to a sprayer, particularly to a microdroplet generation apparatus having higher atomization efficiency.

2. Description of the Related Art

In the conventional sprayers and related prior arts, there are basically two means to generate atomized droplets. One is using the vibration of a piezoelectric material to squeeze a liquid out of a nozzle disc to generate microdroplets. Another means is using a piezoelectric material to vibrate a nozzle disc, and using the vibration of the nozzle disc to atomize a liquid into microdroplets. In some cases, the latter means adopts a liquid-vibration plane. For example, a bundle of capillary tubes is used to transport a liquid, and the terminals of the capillary tubes are fabricated into a plane. The liquid flowing to the plane is vibrated and atomized into microdroplets. Alternatively, a compressor is used to transport a liquid to the nozzle disc, and the vibrating nozzle disc atomizes the liquid into microdroplets. In the latter means, whether the vibration energy is efficiently conducted to the nozzle disc depends on whether the piezoelectric material and the nozzle disc are joined well.

In the conventional sprayers using an oscillation plate to conduct vibration to the nozzle disc, a connection plate or fixing plate is usually interposed between the nozzle disc and the oscillation plate and joined to them with an adhesive material because the nozzle disc is small and thin. Then, at least two materials exist between the nozzle disc and the oscillation plate. Thus, there is a problem of vibration conduction efficiency in addition to the problem of joining multiple materials. When the oscillation plate passes vibration through several different materials to the nozzle disc, there is energy loss in each energy transfer between two different materials. Consequently, the liquid atomization effect is reduced.

### SUMMARY OF THE INVENTION

The primary objective of the present invention is to provide a microdroplet generation apparatus, which applies to a sprayer, wherein the oscillation plate is well joined to the nozzle disc, whereby vibration energy is effectively conducted to the nozzle disc, and liquid atomization is improved.

To achieve the abovementioned objective, the present invention proposes a microdroplet generation apparatus, which comprises an oscillation plate, a connection plate, a nozzle disc and a bonding material, wherein the nozzle disc is interposed between the oscillation plate and the connection plate, and wherein the oscillation plate, the connection plate and the nozzle disc are joined with the bonding material. The oscillation plate and the connection plate respectively have a first through-hole and a second through-hole corresponding to each other. The nozzle disc has a plurality of injection holes on the area corresponding to the first through-hole and the second through-hole. The nozzle disc has a plurality of via-holes on the area not corresponding to the first through-hole and the second through-hole. The bonding material passes through the via-holes of the nozzle disc to join the oscillation plate and the connection plate and fix the nozzle disc in between the oscillation plate and the connection plate.

The present invention is characterized in that the nozzle disc is designed to have a plurality of via-holes allowing the bonding material to pass and enabling the bonding material to effectively join the oscillation plate, the connection plate and the nozzle disc, whereby vibration energy can be directly transmitted from the oscillation plate to the nozzle disc.

The nozzle disc may be a single-piece structure or a two-piece structure containing a fixing plate.

Below, the embodiments are described in detail in cooperation with the drawings to make easily understood the technical characteristics and efficacies of the present invention.

### BRIEF DESCRIPTION OF THE DRAWINGS

FIG. 1 is an exploded view of a microdroplet generation apparatus according to a first embodiment of the present invention;

FIG. 2 is a perspective view of a microdroplet generation apparatus according to the first embodiment of the present invention;

FIG. 3 is a sectional view of a microdroplet generation apparatus according to the first embodiment of the present invention;

FIG. 4 is a sectional view schematically showing that the microdroplet generation apparatus shown in FIG. 1 further comprises an enveloping member;

FIG. 5 is an exploded view of a microdroplet generation apparatus according to a second embodiment of the present invention;

FIG. 6 is a sectional view of a microdroplet generation apparatus according to the second embodiment of the present invention; and

FIG. 7 is a sectional view schematically showing that the microdroplet generation apparatus shown in FIG. 5 further comprises an enveloping member.

### DETAILED DESCRIPTION OF THE INVENTION

Below, the technical contents are described in detail in cooperation with the drawings.

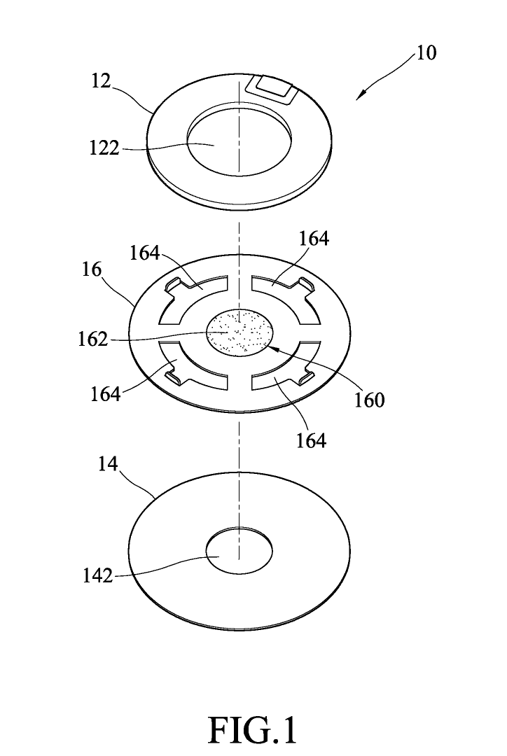

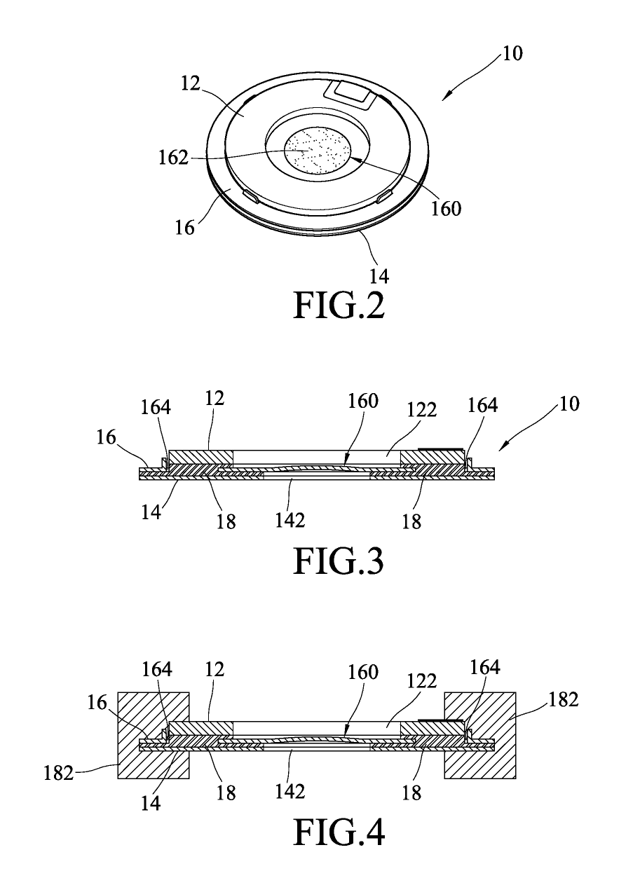

The present invention discloses a microdroplet generation apparatus applying to a sprayer. Referring to FIGS. 1 to 3, FIG. 1 is an exploded view of a microdroplet generation apparatus according to a first embodiment of the present invention. FIG. 2 and FIG. 3 are respectively a perspective view and a sectional view of a microdroplet generation apparatus according to the first embodiment of the present invention. The microdroplet generation apparatus 10 of the first embodiment contains a plurality of plate-like structures stacked together. The microdroplet generation apparatus 10 comprises an oscillation plate 12, a connection plate 14, a nozzle disc 16, and a bonding material 18, wherein the nozzle disc 16 is interposed between the oscillation plate 12 and the connection plate 14, and wherein the bonding material 18 joins the stacked oscillation plate 12, nozzle disc 16 and connection plate 14. The oscillation plate 12 is a circular plate-like structure, preferably a piezoelectric ceramics plate. The oscillation plate 12 has a first through-hole 122 at the center thereof. The connection plate 14 is a circular stainless plate-like stricture and has a second through-hole 142 at the center thereof and corresponding to the first through-hole 122. When the oscillation plate 12 and the connection plate 14 are stacked together, the first through-hole 122 and the second through-hole 142 interconnect.

The nozzle disc 16 is a circular plate-like structure interposed between the oscillation plate 12 and the connection plate 14. The nozzle disc 16 has a plurality of tiny injection holes 162 at the central region corresponding to the first through-hole 122 and the second through-hole 142. The nozzle disc 16 also has a plurality of via-holes 164 on the region not corresponding to the first through-hole 122 and the second through-hole 142, and the via-holes 162 are arranged annularly around the tiny injection holes 162. The bonding material 18 passes through the via-holes 164 to join the oscillation plate 12 and the connection plate 14. The quantity and shape of the via-holes 164 is not limited by that shown in the drawings. On the nozzle disc 16, the region corresponding to the first through-hole 122 and the second through-hole 142 is fabricated into a convex surface 160, and the tiny injection holes 162 are arranged on the convex surface 160.

In the first embodiment, the microdroplet generation apparatus 10 is constructed via stacking together the abovementioned three plate-like structures, wherein the nozzle disc 16 is interposed between the oscillation plate 12 and the connection plate 14, and wherein the bonding material 18 joins the three plate-like structures together. As the nozzle disc 16 has the via-holes 164, the bonding material 18 can pass through the via-holes 164 to join the oscillation plate 12 and the connection plate 14 and fasten the nozzle disc 16 to between the oscillation plate 12 and the connection plate 14. Such a bonding method not only can effectively enhance the bonding strength of the oscillation plate 12 and the nozzle disc 16 but also can effectively transmit vibration energy from the oscillation plate 12 to the nozzle disc 16.

The bonding material 18 may be but not limited to a curable resin or a metallic soldering material.

Referring to FIG. 4, a sectional view schematically shows that the microdroplet generation apparatus of the first embodiment may further comprise an enveloping member 182 used to envelope the joined oscillation plate 12, connection plate 14 and nozzle disc 16. The enveloping member 182 may be but not limited to the O-ring shown in FIG. 4.

From the above description, it is known that the first embodiment of the present invention is characterized in that the nozzle disc 16 is designed to have a plurality of via-holes 162 allowing the bonding material 18 to pass and enabling the bonding material 18 to effectively join the oscillation plate 12, the connection plate 14 and the nozzle disc 16, whereby vibration energy can be directly transmitted from the oscillation plate 12 to the nozzle disc 14. Therefore, the present invention can effectively reduce energy loss in vibration conduction.

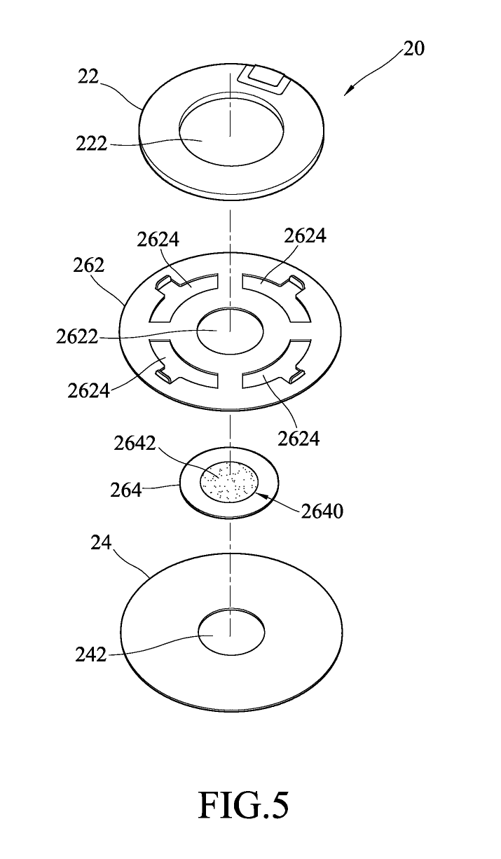

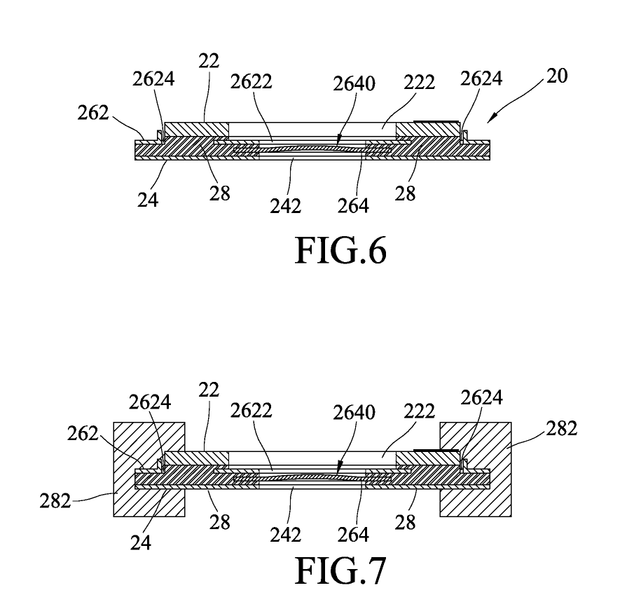

Referring to FIG. 5 and FIG. 6, FIG. 5 and FIG. 6 respectively show an exploded view and a sectional view of a microdroplet generation apparatus according to a second embodiment of the resent invention. In the second embodiment, the microdroplet generation apparatus 20 also contains several plate-like structures. However, in comparison with the three-pieces structure microdroplet generation apparatus 10 of the first embodiment, the microdroplet generation apparatus 20 is a four-pieces structure in the second embodiment. The microdroplet generation apparatus 20 comprises an oscillation plate 22, a connection plate 24, a fixing plate 262, a nozzle disc 264 and a bonding material 28, wherein the bonding material 28 joins the stacked oscillation plate 22, connection plate 24, fixing plate 262 and nozzle disc 264. The oscillation plate 22 is a circular plate-like structure, preferably a piezoelectric ceramics plate. The oscillation plate 22 has a first through-hole 222 at the center thereof. The connection plate 24 is a circular stainless plate-like stricture and has a second through-hole 242 at the center thereof and corresponding to the first through-hole 222. When the oscillation plate 22 and the connection plate 24 are stacked together, the first through-hole 222 and the second through-hole 242 interconnect.

The fixing plate 262 is a circular plate-like structure interposed between the oscillation plate 22 and the connection plate 24. The fixing plate 24 has a third through-hole 2622 at the center thereof and corresponding to the first through-hole 222 and the second through-hole 242. Further, the fixing plate 262 has a plurality of via-holes 2624 on the region not corresponding to the first through-hole 222 and the second through-hole 242. The bonding material 28 passes through the via-holes 2624 to join the oscillation plate 22 and the connection plate 24. The quantity and shape of the via-holes 2624 is not limited by that shown in the drawings.

The nozzle disc 264 is a circular plate-like structure interposed between the fixing plate 262 and the connection plate 24. The nozzle disc 264 has a plurality of tiny injection holes 2642 at the central region corresponding to the first through-hole 222, the second through-hole 242 and the third through-hole 2622. A convex surface 2640 is fabricated on the nozzle disc 264, and the tiny injection holes 2642 are arranged on the convex surface 2640.

In the second embodiment, the microdroplet generation apparatus 20 is constructed via stacking together the abovementioned four plate-like structures—the oscillation plate 22, the connection plate 24, the fixing plate 262 interposed between the oscillation plate 22 and the connection plate 24, and the nozzle disc 264 interposed between fixing plate 262 and the connection plate 24, wherein the bonding material 28 joins the four plate-like structures together. As the fixing plate 262 has the via-holes 2624, the bonding material 28 can pass through the via-holes 2624 to join the oscillation plate 22 and the connection plate 24 and fasten the fixing plate 262 and the nozzle disc 264 to between the oscillation plate 22 and the connection plate 24. Such a bonding method not only can effectively enhance the bonding strength of the oscillation plate 22 and the nozzle disc 262 but also can effectively transmit vibration energy from the oscillation plate 22 to the nozzle disc 262.

Referring to FIG. 7, a sectional view schematically is shown that the microdroplet generation apparatus of the second embodiment may further comprise an enveloping member 282 used to envelope the joined oscillation plate 22, connection plate 24, fixing plate 262 and nozzle disc 264. The enveloping member 282 may be but not limited to the O-ring shown in FIG. 7.

In conclusion, the present invention proposes a microdroplet generation apparatus, which applies to a sprayer, wherein the oscillation plate is well joined to the nozzle disc, whereby vibration energy is effectively transmitted to the nozzle disc, and liquid atomization is improved.

The present invention is characterized in that the nozzle disc is designed to have a plurality of via-holes allowing the bonding material to pass and enabling the bonding material to effectively join the oscillation plate, the connection plate and the nozzle disc, whereby vibration energy can be directly transmitted from the oscillation plate to the nozzle disc. In the present invention, the nozzle disc may be a single-piece structure or a two-piece structure containing a fixing plate.

The embodiments described above are only to exemplify the present invention but not to limit the scope of the present invention. Any equivalent modification or variation according to the spirit of the present invention is to be also included within the scope of the present invention.

What is claimed is:

1. A microdroplet generation apparatus, which applies to a sprayer, comprising
an oscillation plate having a first through-hole;
a connection plate having a second through-hole corresponding to said first through-hole;
a nozzle disc interposed between said oscillation plate and said connection plate, having a plurality of tiny injection holes on a region corresponding to said first through-hole and said second through-hole, and having a plurality of via-holes on a region not corresponding to said first through-hole and said second through-hole; and
a bonding material passing said via-holes of said nozzle disc to join said oscillation plate and said connection plate and fasten said nozzle disc to between said oscillation plate and said connection plate.

2. The microdroplet generation apparatus according to claim 1, wherein said oscillation plate is a piezoelectric ceramics plate.

3. The microdroplet generation apparatus according to claim 1, wherein on said nozzle disc, said region corresponding to said first through-hole and said second through-hole is fabricated into a convex surface, and said tiny injection holes are arranged on said convex surface.

4. The microdroplet generation apparatus according to claim 1, wherein said connection plate is made of a stainless-steel plate.

5. The microdroplet generation apparatus according to claim 1, wherein said bonding material is a curable resin.

6. The microdroplet generation apparatus according to claim 1, wherein said bonding material is a metallic soldering material.

7. The microdroplet generation apparatus according to claim 1 further comprising an enveloping member used to envelope said oscillation plate, said connection plate and said nozzle disc, which have been joined by said bonding material.

8. The microdroplet generation apparatus according to claim 7, wherein said enveloping member is an O-ring.

9. A microdroplet generation apparatus, which applies to a sprayer, comprising
an oscillation plate having a first through-hole;
a connection plate having a second through-hole corresponding to said first through-hole;
a fixing plate interposed between said oscillation plate and said connection plate, having a third through-hole corresponding to said first through-hole and said second through-hole, and having a plurality of via-holes on a region not corresponding to said first through-hole and said second through-hole;
a nozzle disc interposed between said fixing plate and said connection plate and having a plurality of tiny injection holes on a region corresponding to said first through-hole, said second through-hole and said third through-hole; and
a bonding material passing said via-holes of said fixing plate to join said oscillation plate, said connection plate and said nozzle disc and fasten said fixing plate to between said oscillation plate and said connection plate.

10. The microdroplet generation apparatus according to claim 9, wherein said oscillation plate is a piezoelectric ceramics plate.

11. The microdroplet generation apparatus according to claim 9, wherein on said nozzle disc, said region corresponding to said first through-hole, said second through-hole and said third through-hole is fabricated into a convex surface, and said tiny injection holes are arranged on said convex surface.

12. The microdroplet generation apparatus according to claim 9, wherein said connection plate is made of a stainless-steel plate.

13. The microdroplet generation apparatus according to claim 9, wherein said bonding material is a curable resin.

14. The microdroplet generation apparatus according to claim 9, wherein said bonding material is a metallic soldering material.

15. The microdroplet generation apparatus according to claim 9 further comprising an enveloping member used to envelope said oscillation plate, said connection plate, said fixing plate and said nozzle disc, which have been joined by said bonding material.

16. The microdroplet generation apparatus according to claim 15, wherein said enveloping member is an O-ring.
